(19) United States
(12) Patent Application Publication
(10) Pub. No.: US 2014/0279711 A1
(43) Pub. Date: Sep. 18, 2014

(54) VISUALIZING ENERGY CONSUMPTION AND COST TRENDS USING VIRTUAL BILLING CYCLE CALCULATIONS AND STATISTICAL ANALYSIS

(71) Applicant: ITRON, INC., Liberty Lake, WA (US)

(72) Inventors: Bruce Christopher Angelis, Valleyford, WA (US); Andrew Ray Walker, Spokane, WA (US)

(73) Assignee: ITRON, INC., Liberty Lake, WA (US)

(21) Appl. No.: 13/839,277

(22) Filed: Mar. 15, 2013

(51) Int. Cl. G06Q 50/06; G06Q 30/04

(52) U.S. Cl. CPC G06Q 50/06; G06Q 30/04
USPC 705/412

(57) ABSTRACT

A utility consumption information system establishes a virtual billing cycle to enable a user to calculate a bill-to-date cost of utility service related to a certain site without waiting for a utility bill sent from an associated utility service provider. The utility consumption information system provides utility consumption information to a user in an informative user interface and enables the user to monitor utility consumption associated with the site. Moreover, the utility consumption information system allows the user to compare the utility consumption of the site with one or more references, and thus assists the user to determine whether a change in the utility consumption is due to an external factor or an internal factor.

### BACKGROUND

Consumption or usage information of a utility service (such as gas, water, electricity, etc.) is valuable not only to utility service providers but also utility service consumers. Utility service providers have utility metering systems that collect time series utility consumption information for residential and commercial sites and can use this utility consumption information to determine or estimate an amount of utility service consumed in an interval of time or time window. In contrast, utility service consumers may receive utility consumption information only on an accumulated monthly basis, bounded in time by the entire billing cycle (usually 20 to 31 days in the United States). Such infrequent feedback from the utility service does not provide adequate information to consumers to modify their behavior in response to costs.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment implementing a utility consumption information system.

FIG. 2 illustrates the example utility consumption information system in more detail.

FIG. 3 illustrates a first example user interface displaying utility consumption information.

FIG. 4 illustrates a second example user interface displaying utility consumption information.

FIG. 5 illustrates a third example user interface displaying utility consumption information.

FIGS. 6A-6C illustrate a fourth example user interface enabling a user of the utility consumption information system to update profile information.

FIG. 7 illustrates an example method to provide utility consumption information.

### DETAILED DESCRIPTION

### Overview

As noted above, utility service consumers are not provided with time series utility consumption information, and therefore cannot monitor or control utility usage in a knowledgeable and/or intelligent manner.

This disclosure describes a utility consumption information system, which provides a user with informative data related to their utility consumption. The system may also provide the user with the ability to monitor utility usage in real time and determine factors that affect the utility usage in a timely and easily understood manner.

In one implementation, the utility consumption information system may display consumption information of a utility service (such as water, gas, electricity, etc.) associated with a site on a regular basis, continuously and/or at a request of the user. The site may include a real estate site such as a residential or commercial site, or a room, an apartment, a house, an office, a multi-unit building, etc. Additionally or alternatively, in some implementations, the site may be limited to one or more appliances (e.g., a water heater, a furnace, an air conditioning system, etc.), etc. The user may include a utility service consumer, an authorized agent of an associated utility service provider and/or a maintenance person of the site.

The utility consumption information system may provide or display a variety of data that is based on and/or derived from the utility consumption or usage associated with the site. In one implementation, the utility consumption information system may derive data to be provided or displayed by applying a rolling or sliding window to utility consumption or usage data obtained at the site over a period of time. The utility consumption information system may predefine a width or size of the sliding (or rolling) window. Additionally or alternatively, in some implementations, the utility consumption information system may enable the user to predefine the width of the sliding window. Additionally, in one implementation, the utility consumption information system (or the user if allowed by the utility consumption information system) may set different weights for different time points of the window (e.g., a nighttime price of electricity may be lower than a daytime price).

By way of example and not limitation, the utility consumption information system may employ a virtual billing cycle (VBC) to provide the user with information. The virtual billing cycle may include starting and ending dates that are different from a customer's actual billing cycle. Additionally or alternatively, in some implementations, the VBC may provide the customer with an estimate of an actual bill if current behavior is continued and/or modified. Thus, the VBC may help a user to calculate costs and function as a foundation for setting up contexts of past, current and/or future utility usage and/or respective associated costs, environmental impacts and the like. The virtual billing cycle may include a range of time (such as hours, days, weeks, months, etc., and frame a consumption profile associated with the utility and its associated computed factors. The associated computed factors may include, for example, calculated costs based on relevant utility rates. In some implementations, the utility consumption information system may adopt a same rate or cost calculation that may be used in an actual process of computing a cost or fee for the utility consumption measured by a utility meter. The utility consumption information system may compare similarities and differences between actual utility billing cycles (UBCs) and a plurality of virtual billing cycles, and create one or more scalar values (that may be referred to as VBC vital signs) which represent these similarities and differences. The utility consumption information system may compute past, current and/or future impact indicators based on one or more of the VBC vital signs.

The utility consumption information system may provide these data and/or impact indicators in a variety of forms including, for example, textual, tabular, graphical and/or animation formats. Examples of data and/or impact indicators may include, but are not limited to, an absolute and/or relative value of the utility consumption at one point of time or within a time interval, a cumulative value of the utility consumption over a period of time, a peak value of the utility consumption within a time interval, etc. Additionally or alternatively, the data and/or impact indicators may include a rate of change of the utility consumption over a period of time, a trend of the utility consumption over a period of time, a progress of the utility consumption with respect to one or more target, goal or baseline references, etc. In one implementation, the utility consumption information system may obtain these data and/or impact indicators based on an application of a rolling or sliding window of time.

In some instances, the utility consumption information system may display the derived data against one or more references or benchmarks. This may allow the user to determine whether one or more changes in the utility consumption data associated with the site are attributed to external or environmental factors (such as a weather change, for example) or internal factors (e.g., changing numbers of housemates at the site, etc). Examples of the one or more references may include utility consumption associated the site in a previous time period (e.g., last year, last month, last week, yesterday, etc.), a utility consumption goal set up by the user, utility consumption associated with a virtual or peer site over the same time period for the data, etc. The peer site may include a site having a type of relevance associated with the site of which utility consumption data is to be displayed in the utility consumption information system. The type of relevance may include, for example, a location relevance, e.g., being located within a predetermined distance from the site, within a same area (such as a same district, a city, a state, etc.), etc. Additionally or alternatively, the type of relevance may include a functional relevance, e.g., having a function or use similar to a function or use of the site. The virtual site may include an overall representation (such as a weighted average representation) of a plurality of peer sites associated with the site for which utility consumption data is to be displayed.

The described system displays timely utility consumption information about a site to a user and enables the user to monitor utility consumption related to the site. The utility consumption information system further allows the user to compare the utility consumption of the site with one or more references (e.g., utility consumption of other sites), and facilitates the user to determine whether a change in the utility consumption is due to an external factor and/or an internal factor. Moreover, the use of virtual billing cycle(s) may allow a user to calculate usage and cost of actual current virtual billing cycle, and optionally to alter behavior before conclusion of an actual or current billing cycle.

The application describes multiple and varied embodiments and implementations. The following section describes an example environment that is suitable for practicing various implementations. Next, the application describes example systems, devices, and processes for providing utility consumption information.

### Example Environment

FIG. 1 is a schematic diagram of an example environment 100 implementing a utility consumption information system 102. The environment 100 may further include one or more utility metering devices 104-1, 104-2, 104-3, . . . , 104-N (collectively referred to as utility metering devices 104) associated or installed with one or more sites 106-1, 106-2, . . . , 106-M (collectively referred to as sites 106). In some implementations, the environment 100 may include one or more servers 108. In this example, the utility consumption information system 102 may communicate with the one or more utility metering devices 104 and/or the one or more servers 108 over a communication network 110.

In FIG. 1, the utility consumption information system 102 is shown to be an individual or separate entity from the utility metering devices 104, the sites 106 and the servers 108. However, in some implementations, the utility consumption information system 102 may be included in a utility metering device 104, a site 106 and/or the one or more servers 108. Furthermore, some or all of the functions of the utility consumption information system 102 may be implemented in the utility metering devices 104, the sites 106 and/or the servers 108.

Additionally or alternatively, the utility consumption information system 102 may be an application or service provided in a computing device and may provide utility consumption data in a display of the computing device. The computing device may be a mainframe computer, a server, a notebook or portable computer, a handheld device, a netbook, an Internet appliance, a tablet or slate computer, a mobile device (e.g., a mobile phone, a personal digital assistant, a smart phone, etc.), a game console, etc., or a combination thereof.

In one implementation, the site of utility consumption may be a real property such as a residential or commercial property, a room, an apartment, a house, an office, a multi-unit building, etc. Additionally or alternatively, the site may be an appliance or other utility-consuming device (e.g., a water heater, a furnace, an air conditioning system). In some implementations, the site may include one or more residential (or commercial) properties and/or appliances sharing a common utility metering device, such as the utility metering device 104-2.

Furthermore, the communication network 110 may be a wireless or a wired network, or a combination thereof. The network 110 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. In some implementation, the communication network 110 may include one or more types of communication channels, such as a power line communication (PLC) channel, a radio frequency (RF) channel, a physical cable channel, etc.

In one implementation, the utility metering devices 104 may be implemented as one of a variety of devices, which may include smart utility meters (e.g., electric, gas, heat, and/or water meters), sensors (e.g., temperature sensors, weather stations, frequency sensors, etc.), control devices, transformers, routers, servers, relays (e.g., cellular relays), switches, valves, or a combination of the foregoing.

Additionally, in some implementations, the utility metering device 104 (as representative by the utility metering device 104-N in FIG. 1) may include a processing unit 112. The processing unit 112 may include one or more processor(s) 114 communicatively coupled to memory 116. The memory 116 may be configured to store one or more software and/or firmware modules, which are executable on the processor(s) 114 to implement various functions. While the modules are described herein as being software and/or firmware stored in memory and executable on a processor, in other implementations, any or all of the modules may be implemented in whole or in part by hardware (e.g., as an ASIC, a specialized processing unit, etc.) to execute the described functions.

The memory 116 may comprise computer-readable media and may take the form of volatile memory, such as random access memory (RAM) and/or non-volatile memory, such as read only memory (ROM) or flash RAM. Computer-readable media includes volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include communication media, such as modulated data signals and carrier waves.

The utility metering device 104 may include a communication connection 118. The communication connection 118 may include a wireless connection (such as a WiFi connection, a radio frequency (RF) channel connection or a Bluetooth® connection, etc.), a wired connection (such as USB, Ethernet, PLC, or other physical cable connection, etc.), or both wireless and wired connections.

The environment 100 may include a central office 120, which may be part of a utility service provider or company. The central office 120 may include a centralized meter data management system to perform processing, analysis, storage, and/or management of data received from one or more of the utility metering devices 104. For instance, the central office 120 may process, analyze, store, and/or manage data obtained from a smart utility meter, sensor, control device, router, regulator, server, relay, switch, valve, and/or other devices. Additionally or alternatively, the central office 120 may include a network management system (NMS) for maintaining a registry of devices of the AMI network, device configuration settings, version information, and the like. Although the example of FIG. 1 illustrates the central office 120 in a single location, the central office 120 may be distributed amongst multiple locations (e.g., the servers 108) or may be eliminated entirely (e.g., in the case of a highly decentralized distributed computing platform).

A user 122 may be interested in monitoring and/or determining utility consumption or usage associated with a specific site (e.g., the site 106-1), and employ the utility consumption information system 102 to provide utility consumption information of that site.

FIG. 2 illustrates the utility consumption information system 102 in more detail. In one implementation, the utility consumption information system 102 may include one or more processors 202, a network interface 204, memory 206, and an input/output interface 208. The processor(s) 202 is configured to execute instructions received from the network interface 204, received from the input/output interface 208, and/or stored in the memory 206. The memory 206 may include computer-readable media.

In one implementation, the utility consumption information system 102 may further include program modules 210 and other program data 212. The program modules 210 may include an acquisition module 214 that obtains or retrieves utility consumption information from a utility metering device 104 associated with a site 106. Without loss of generality, the acquisition module 214 is described to obtain utility information associated with the site 106-1 from the utility metering device 104-1 hereinafter. The obtained or retrieved utility information may include raw data (such as consumption usage reading of a utility service) measured and/or outputted by the utility metering device 104-1 for the site 106-1. In some implementations, the obtained or retrieved utility information may include identification information (such as a device identifier) of the utility metering device 104-1 and/or identification information (such as a consumer identifier, an address, etc.) of the site 106-1.

The acquisition module 214 may obtain or retrieve this utility consumption information from the utility metering device 104-1 continuously or on a regular basis, such as every second, minute, hour, day, etc. The acquisition module 214 may obtain or retrieve the utility consumption information from the utility metering device 104-1 associated with the site 106-1 in response to receiving a request from the central office 120 or the user 122. The utility consumption information system 102 may include an input module 216 that emulates a soft input control on a display 218 and/or provides a hard input control for the user 122 to enter and/or select an instruction. Additionally or alternatively, the acquisition module 214 may obtain or retrieve the utility consumption information associated with the site 106-1 from an associated utility service provider. The utility service provider may provide utility consumption information associated with a plurality of sites 106 through its server (e.g., the servers 108 or the central office 120) or website (which may be hosted in the server 108, for example). The utility consumption information system 102 (or the acquisition module 214) may be allowed to download the utility consumption information associated with the site at issue (i.e., the site 106-1 in this example) from the server 108 or a website of the utility service provider after the utility service provider receives and verifies authentication or identification information sent from the utility consumption information system 102. In one implementation, the authentication or identification information may include, for example, a username and a password set up for that site, a pass code or encryption/decryption key set up between the utility consumption information system 102 and the server 108 or the website of the utility service provider, etc.

Regardless of how the utility consumption information associated with the site is obtained, a processing module 220 of the utility consumption information system 102 may process the obtained utility consumption information associated with the site 106-1 after obtaining the utility consumption information. In one implementation, the processing module 220 may employ a virtual billing cycle (VBC) as a foundation for setting up context of past, current and/or future utility usage and/or respective associated costs, environmental impacts, etc. A billing cycle is “virtual” in the sense that it may have different start and/or end dates than an actual billing cycle for a particular customer. However, the VBC provides a tool for calculating a cost for utility consumption up to date. If a time period of a virtual billing cycle matches a time period of an actual billing cycle used by the utility service provider, the virtual billing cycle may be the same as the actual billing cycle. The processing module 220 may create the virtual billing cycle by applying a rolling or sliding window to utility consumption data obtained over a period of time or a number of time points.

The processing module 220 may use the virtual billing cycle to frame or represent a consumption profile and associated computed factors (e.g., an estimated cost based on a relevant utility rate). The processing module 220 may use a same rate or cost calculation method that is used in an actual process of computing a cost for the utility consumption measured by a utility meter (such as the utility metering device 104-1). The processing module 220 may compare similarities and differences between actual utility billing cycles (UBCs) and a plurality of virtual billing cycles, and create one or more scalar values called VBC vital signs that represent these similarities and differences. The processing module 220 may compute past, current and/or future impact indicators based on one or more of these VBC vital signs.

The virtual billing cycle may include data based on a range or granularity of time or time points (such as hours, days, weeks, months, etc.) defined by the utility consumption information system 102 and/or the user 122 in advance or at a time of receiving a user request. Examples of the virtual billing cycle may include a current VBC, a previous point-in-time VBC, a peer VBC, a profile VBC, a goal VBC, etc. Given that a virtual billing cycle has N time points, where N is an integer greater than or equal to one, definitions of the above example VBCs are given as follows:

Current VBC=(actual values in most recent N time points of UBC−actual values in the oldest n time points of UBC)+actual values in the post n time points of UBC, where 0≦n≦N.

Previous point-in-time VBC=Consumption profile at a predetermined number of time points previous to a current VBC.

Peer VBC=Average of current VBCs of peer users or sites.

Profile VBC=Archetype profile of current VBC.

Goal VBC=Current VBC factored with a specified goal of the user 122.

The foregoing VBCs are merely examples for illustrative purpose only. Further, the processing module 220 may adopt one or more different types of VBCs to compare with the utility consumption information obtained from the utility metering device 104-1. For example, the processing module 220 may compare one or more VBCs against the utility consumption information that is obtained from the utility metering device 104-1. Example VBCs may include utility consumption associated with the site 106-1 in a previous time period (e.g., last year, last month, last week, yesterday, etc.), a utility consumption goal set up by the user, utility consumption associated with a virtual or peer site over the same time period for the data, etc. A peer site may include a site (e.g., another residential customer) relevant to the site for which utility consumption data is to be displayed by the utility consumption information system. The type of relevance may include similar structure (e.g., a similar house or apartment), a similar climate (e.g., the same city) a similar occupancy (e.g., a similar family size). Additionally or alternatively, the type of relevance may include a functional relevance (e.g., a same or similar business). The virtual site may include an overall representation (such as a weighted average representation) of a plurality of peer sites associated with the site of which utility consumption data is to be displayed.

The processing module 220 may compute statistical data based on or derived from the obtained utility consumption information. The statistical data may include an absolute and/or relative value of the utility consumption at one point of time or within a time interval, a cumulative value of the utility consumption over a period of time, a peak value of the utility consumption within a time interval, etc. Additionally or alternatively, the statistical data may include a rate of change of the utility consumption over a period of time, a trend of the utility consumption over a period of time, a progress associated with the utility consumption with respect to one or more target or baseline references, etc. The utility consumption information system may obtain these statistical data based on an application of a rolling or sliding window. The processing module 220 may compute one or more of statistical data and references (e.g., VBCs) before or upon receipt of the utility consumption information. The processing module 220 may compute one or more of the statistical data and references in real time upon receiving a request from the user 122.

In some implementations, the processing module 220 may further calculate an actual or current utility bill cost or fee based on a virtual billing cycle. For example, the processing module 220 may generate a current virtual billing cycle that has a same time period (or a same time duration) as an actual or current billing cycle, e.g., twenty-eight days for February, thirty days for April, thirty-one days for January, etc. In one implementation, the current virtual billing cycle may include two components. The first component includes utility consumption data over a time period within the actual or current billing cycle that has already been lapsed or past. The second component includes utility consumption data over a previous time period. In one instance, the previous time period may include a same time duration as the remaining time period of the current virtual billing cycle but at an earlier time such as the same time period of last month or last year, etc. In some instances, the utility consumption data over the previous time period may include a weighted average of utility consumption data over a plurality of previous time periods with weights being equal for each previous time period or higher for a previous time period that is closer to a time period of the actual billing cycle. The processing module 220 may calculate a utility cost for the current virtual billing cycle by converting the utility consumption data of the current virtual billing cycle to an estimated utility cost using a utility rate and/or a utility calculation algorithm provided by the associated utility service provider.

For example, a time period of an actual billing cycle may be from Jan. 1, 2012 to Jan. 31, 2012, and today may be Jan. 15, 2012. A current virtual billing cycle may include the 30 or 31 days prior to the actual date. Thus, if the current virtual billing cycle is said to be 31 days, the current virtual billing cycle may include 15 days (or 14 days if today's utility consumption information is not counted or completed) in January that have known consumption levels and known billing rates. The current virtual billing cycle may also include the last 16 days (or 17 days if today's utility consumption information is not counted or completed) in December 2011. As the days pass, the consumption level and cost expressed by the current virtual billing cycle more nearly represents the actual billing cycle (i.e., the month of January). Thus, as days pass, the current virtual billing cycle becomes progressively more accurate as is “overlaps” the actual billing cycle. Significantly, the user 122 may observe the consumption and/or cost values of the current virtual billing cycle and associate those values with behavior of the user 122 (e.g. heat settings in a house). Thus, a virtual billing cycle is a tool that the user 122 may employ to better understand the link between behavior, consumption and cost. Also, the virtual billing cycle is a tool that the user 122 may employ to more easily predict or calculate the actual bill at the end of the actual billing cycle.

Upon obtaining statistical data and one or more references (or upon receiving a request from the user 122 to display the statistical data and/or one or more references), a display module 222 of the utility consumption information system may display one or more of the statistical data and/or references upon request, continuously, or on a regular basis. Furthermore, the display module 222 may display the one or more of the statistical data and/or references in a single page or in multiple pages. In an event that the statistical data and/or references are displayed in multiple pages, the display module 222 may automatically switch from one page to another page after a predefined time interval. Alternatively, the user 122 may switch from page to page manually using a button provided by the utility consumption information system 102. In one implementation, the display module 222 may display the one or more of the statistical data and/or references in textual, tabular, graphical and/or animation form. The display module 222 may select a form or format to display the one or more statistical data and/or references based on a preference of the user 122, a default setting of the utility consumption information system 102 and/or a display capability of the utility consumption information system 102.

The utility consumption information system 102 may include a log database 224. The log database 224 may store the utility consumption data of the site 106. The log database 224 may also store data representing one or more virtual billing cycles. The log database 224 may store predefined settings of the utility consumption information system 102 and/or instructions received from the user 122.

### Example User Interfaces

FIGS. 3-5 illustrate example user interfaces displaying statistical data and references of the utility consumption information that are of interest to the user 122. The example user interfaces may also display aspects of a virtual or rolling billing cycle. These example user interfaces are representative of user interfaces usable with a utility consumption system and/or virtual billing cycle techniques discussed herein.

FIG. 3 shows a first example user interface 300 displaying statistical data and references related to utility consumption information. In this example, the user 122 receives utility information from the site 106-1. In one implementation, the user interface 300 may display one or more references 302-1, 302-2, . . . , 302-R (collectively referred to as references 302). R is an integer greater than or equal to one. The user interface 300 may represent these references 302 differently by colors, labels, graphical objects, shapes, positions, etc. By way of example and not limitation, the reference 302-1 is labeled with “L” representing billing cycle at this time last (“Last”) month or month in last year. The reference 302-2 is labeled with “P” representing a virtual billing cycle of a peer (“Peer”) or virtual site of the site 106-1 at a current time period or time point. The reference 302-R is labeled with “G” representing a goal (“Goal”) or preferred utility consumption of the site 106-1 set up by the user 122.

The one or more references 302 may include, but are not limited to, a virtual billing cycle of the site 106-1 at a previous time period or time point, a virtual billing cycle of a peer or virtual site of the site 106-1 at a current time period or time point, a goal or desired utility consumption of the site 106-1 set up by the user 122, and/or a weighted combination of one or more of these.

Additionally or alternatively, the one or more references 302 may include, for example, a peak value of utility consumption of the site 106-1 at a previous time period or time point, a peak value of utility consumption of a peer or virtual site of the site 106-1 at a current time period or time point, a target peak value of utility consumption of the site 106-1 set up by the user 122, and/or a weighted combination of one or more of these.

The user interface 300 may further include one or more graphical objects. For example, the user interface 300 may include a volume indicator or object 304 having one or more attributes that represent information of utility consumption associated with the site 106-1.

For example, a size of the volume object 304 may represent a relative or absolute amount of utility service consumed by the site 106-1 in a currently displayed time period or at a currently displayed time point. Thus, a larger object 304 may represent a higher rate of consumption, and consumers may gauge their consumption based in part in a size of the object 304. In some implementations, a direction (indicated, for example, by arrow or leading indicator 306) may represent a trend of the utility consumption of the site 106-1. That is, consumption may be on a downward trend (down arrow) or an upward trend (up arrow). The trend may be based on what is happening within a current virtual billing cycle (or time period) or based on a comparison of the current virtual billing cycle (time period) to a previous virtual billing cycle (time period).

Additionally or alternatively, a position of the volume object 304 with respect to the one or more references 302 may represent an improvement, a difference and/or a progress associated with utility consumption of the site 106-1 as compared to the one or more references 302. For example, the user interface 300 may show how far the volume object 304 is away from the one or more references 302 (such as L, P and/or G references).

Additionally or alternatively, in some implementations, the volume object 304 may gradually change to different colors when the volume object 304 approaches different references 302. Although the volume object 304 is illustrated as a circle in FIG. 3, the user interface 300 may display the volume object 304 in a different shape such as a square, a rectangle, a triangle (with one vertex pointing up or down indicating its moving direction) or an arbitrary shape. The user interface 300 may display the volume object 304 in a shape that is predefined by the utility consumption information system 102 or selected by the user 122.

Additionally or alternatively, the user interface 300 may display one or more ripples 308-1, 308-2, . . . , 308-K (collectively referred to as ripples 308) generated behind the volume object 304. K is an integer greater than or equal to one. A position (e.g., a center) and/or a size of each ripple 308 may represent a magnitude of utility consumption of the site 106-1 in a previous time period or at a previous time point. In some implementations, a rate of change of differences or separations between positions of two successive ripples 308 indicates a rate of change of utility consumption of the site across respective virtual billing cycle, time periods or time points. Thus, closely spaced ripples may indicate slow change in energy consumption, while more distantly spaced ripples indicate more rapid changes in energy consumption. Moreover, the size and location of the ripples may indicate the previous consumption rates.

In some implementations, the user interface 300 may further include a bar object 310 displaying a gradual change of color from one end to the other end. In one implementation, the color of the volume object 304 at a certain position (e.g., a position of a center of the volume object 304) may match or resemble a color at a corresponding position in the bar object 310. In the implementation, green may be used to indicate a lower consumption level, yellow may indicate intermediate consumption, and red may indicated higher consumption. In other implementations, a size, height or length of the bar object 310 may indicate a virtual billing cycle value. Thus, the user 122 can immediately visualize an approximate value of an actual billing cycle invoice by quick observation of the bar object. By viewing the bar object 310, and understanding the virtual billing cycle meaning, the user 122 may determine if past behavior should be continued.

In one implementation, the user interface 300 may include a first numeral value 312 indicating a up-to-date cost or value of the utility bill within an actual or current utility billing cycle. In some implementations, the user interface 300 may include a second numeral value 314 indicating a previous utility service cost of an actual utility billing cycle (e.g., an actual utility bill for last month) or a virtual utility service cost of a previous virtual billing cycle. In one implementation, the user interface 300 may display a current time and date 316 to the user 122. Depending on whether a single page or multiple pages are used for displaying related statistics and/or references associated with the utility consumption of the site 106-1, the user interface 300 may include a switch 318 to enable the user 122 to select a particular page for display. The switch 318 may include tabs with labels indicating types of data to be displayed. Additionally or alternatively, the switch 318 may include a scroll bar to enable the user 122 to scroll to a different page.

In some implementations, the user interface 300 may further include a time slider 318 that shows how many days have lapsed within an actual or current utility billing cycle. In one implementation, the user interface 300 may include actual or historical data (e.g., the up-to-date utility cost within a current month or current utility billing cycle, the utility bill for last month or for the same month in the previous year, the current date and time, etc.) and virtual data (e.g., trends, comparisons, and other data representative of the virtual billing cycle, etc.). For example, the user interface 300 may show the actual data above the virtual data as indicated by a separation line 320 (which may or may not be shown in the user interface 300).

FIG. 4 shows a second example user interface 400 displaying statistical data and references related to utility consumption information. In this example, utility consumption information of a site (e.g., site 106-1) of the user 122 is shown with utility consumption information of a peer site as determined in the foregoing implementations. For example, the user interface 400 may include a self utility consumption graphical chart 402 associated with the site of the user 122 and a peer utility consumption graphical chart 404 that is associated with a peer site (e.g., site 106-2). In one implementation, the self utility consumption graphical chart 402 is shown alongside the peer utility consumption graphical chart 404 in the user interface 400. This side-by-side illustration of the two graphical charts 402 and 404 enables the user 122 to visually compare or determine differences between utility consumption of the site of the user 122 and its peer site.

In some implementations, the graphical charts 402 and 404 may further include respective past and current utility usage levels for both sites with indications of one or more past billing dates 406, a most recent billing date 408, and one or more next or future billing dates 410. This helps the user 122 to navigate the graphical charts 402 and 404, and determine whether there is any abnormality (such as excess utility usage, for example) in a certain billing period. Furthermore, in one implementation, the user interface 400 may also include predicted utility usage levels 412 (for example, dotted-line portions that are past or to the right of an indicator “today” 414) for both sites (i.e., the site associated with the user 122 and the peer site). These predicted utility usage levels 412 may equip the user 122 with information to plan ahead for utility consumption in days to come, e.g., before the next or future billing date 410.

In one implementation, the user interface 400 may further include a difference graphical chart 416 that is obtained by subtracting the utility usage level associated with the site of the user 122 by the utility usage level associated with the peer site, for example. This difference graphical chart 416 visually shows differences between the two utility usage levels of the site of the user 122 and the peer site, and therefore further helps the user 122 to compare the utility consumption of the site with the utility consumption of the peer site visually.

Although in the example of FIG. 4, the peer utility consumption graphical chart 404 shows utility consumption or usage levels of a single peer site, in some implementations, the peer utility consumption graphical chart 404 may show an average of utility consumption or usage levels of a plurality of peer sites as determined and described in the foregoing implementations.

FIG. 5 shows a third example user interface 500 of displaying statistical data and references related to utility consumption information. In this example, statistics and/or references associated with utility consumption of a site (e.g., the site 106-1) are displayed in textual and/or tabular forms. A self-comparison chart 502 allows the user 122 to compare the present to past utility usage. A peer comparison chart 404 allows the user 122 to compare current usage levels to current usage levels of peers (e.g., other similarly situated utility customers). A reference comparison chart allows the user to compare the present usage to a usage goal. For example, the user interface 500 may display absolute values of utility consumption of the site in a current/previous time period (or at a current/previous time point) in a first (or self comparison) table 502 for visual comparison. Additionally or alternatively, the user interface 500 may display absolute values of utility consumption of the site in one or more previous time periods (or at one or more previous time points) in the first (or self comparison) table 502 for visual comparison. Additionally or alternatively, the user interface 500 may display absolute values of utility consumption of the site and one or more peer (or virtual) sites in a current/previous time period or at a current/previous time point in a second (or peer comparison) table 504 for visual comparison by the user 122. Additionally or alternatively, the user interface 500 may display relative values (or differences) of utility consumption of the site with respect to one or more references in a third (or reference comparison) table 506.

Depending on the display capability, the utility consumption information system 102 may employ a graphical user interface (such as the user interface 300 or the user interface 400) or a textual user interface (such as the user interface 500). Further, the utility consumption information system 102 may select a graphical user interface (e.g., as seen in FIG. 3 and/or FIG. 4) or a textual user interface (e.g., as seen in FIG. 5) based on an instruction from the user 122.

In one implementation, the user interface 500 may further include a virtual billing cycle table 508. The virtual billing cycle 508 includes data of one or more virtual billing cycles in a tabular format.

Although the above user interfaces 300-500 show particular types of information related to utility consumption of a site and/or peer sites, these user interfaces 300-500 may further enable the user 122 to switch or toggle between different types of information based on user preference, for example. By way of example and not limitation, the user interface 300 may switch or toggle between the bill-to-date value and an up-to-date consumption level by, for example, selecting the first numeral value 312. Additionally or alternatively, the user interface 300 may enable the user 122 to change his/her goal by selecting the reference 302-R that is labeled with “G” and entering a value for the reference 302-R. Additionally or alternatively, the user interface 300 may enable the user 122 to select, switch or toggle between different peer groups or sites (e.g., a neighbor peer group or site, or a peer group or site having a same function or size as the site, etc.) by selecting the reference 302-2 that is labeled with “P”. The user 122 may perform selection or switching through a soft or hard button provided by the utility consumption information system 102 or the display 218. Additionally or alternatively, in some implementations, in response to selecting the reference 302-2 that is labeled with “ID” in the user interface 300 (or the peer comparison table 504 in the user interface 400, for example), the utility consumption information system 102 may redirect the user 122 to a new user interface (as described in FIG. 6A-6C hereinafter). The new user interface may allow the user 122 to update or create a profile that enables the utility consumption information system 102 to select a suitable, similar or right peer group or site automatically for the site of the user 122.

FIGS. 6A-6C illustrate a fourth user interface 600 that enables the user 122 to input or update profile information related to a site 106 (e.g., the site 106-1). For example, the user interface 600 (as shown in FIG. 6A) may include a request 602 asking whether the user 122 wants to tune, update or create profile information of the site 106. In response, the user 122 may select to create or update the profile information of the site 106 by selecting “Yes” or “No” from a profile-tuning answer box 604 (which may include a list box, a pull-down box, an input text box, voice input, etc.), for example. Upon receiving a positive answer (e.g., “Yes”) from the user 122, the user interface 600 may present a profile-specific question 606 to the user 122. The profile-specific question 606 may include, but is not limited to, one or more questions related to factors of the site 106 that may affect utility consumption and/or one or more questions related to factors of the user 122 that may affect the utility consumption. The one or more questions related to the factors of the site 106 may include, for example, how many doors the site has, how many windows the site has, how old the site is, how large the site is, how many levels the site has, and/or how large a landscaping area associated with the site is, etc. The one or more questions related to the factors of the user 122 may include, for example, how often you work at night, how many people reside in the site, etc. FIG. 6A shows an example question of “How many windows does your home have?” that is presented to the user 122. In one implementation, depending on the capability of the utility consumption information system 102, the interaction between the utility consumption information system 102 and the user 122 may be performed through voice input/output. For example, the user 122 may activate a microphone or voice input function 608 in the user interface 600 to provide one or more answers through voice input.

Upon receiving an answer 610 from the user 122, the user interface 600 may ask the user 122 whether he/she wants to tune the profile further. FIG. 6B illustrates the user interface 600 presenting an additional profile tuning request 612 asking whether the user 122 wants to further tune the profile. The user 122 may choose to tune the profile further by selecting “Yes” or “No” in an additional profile-tuning answer box 614 (which may include a list box, a pull-down box, an input text box, etc.). For example, if the user 122 indicates that he/she wants to provide additional information to further tune the profile (e.g., by selecting “Yes” in the additional profile-tuning answer box 614), the user interface 600 may present a new profile-specific question 616 to the user 122 who may input an answer in a second answer box 618. For example, FIG. 6B shows another example question of “How many doors does your home have?” that is presented to the user 122 in the user interface 600. In an alternative implementation, if the user 122 indicates that he/she does not want to tune the profile further (e.g., by selecting “No” in the additional profile-tuning answer box 614), the user interface 600 may present an acknowledgement 620 as shown in FIG. 6C.

In an alternative implementation, the user interface 600 may present a plurality of profile-specific questions to the user 122 on a single page or multiple pages, and allow the user 122 to selectively answer some (i.e., a subset) or all of the questions presented in the user interface 600 to update or create profile information of the site 106.

In either case, upon receiving the updated or created profile information, the utility consumption information system 102 may search a database of the utility service provider (e.g., a database included in the server 108 or the central office 120 that is accessible to the utility consumption information system 102, etc.). The utility consumption information system 102 may select one or more peer sites that have same or similar profile information with the site 106 of the user 122. For example, the utility consumption information system 102 may select the first N peer sites that have profile information closest to the profile information of the site 106 of the user 122).

Additionally or alternatively, the utility consumption information system 102 may send the profile information of the site 106 to the utility service provider (e.g., the server 108 or the central office 120) which may then match the profile information of the site 106 with profile information of other sites included in the database of the utility service provider. Upon finding one or more other sites having profile information similar to the profile information of the site 106, the utility service provider may send information (such as utility consumption information) of these one or more other sites (i.e., peer sites) to the utility consumption information system 102.

In either case, in some implementations, the utility consumption information system 102 may then analyze and present the information of the peer sites (that have profile information closely matched or similar to the profile information of the site 106) to the user 122 through one or more user interfaces (such as the user interfaces 300, 400 and 500). In one implementation, after updating or creating the profile information of the site 106, the utility consumption information system 102 may update information of a user interface (such as one or more of the user interfaces 300, 400 and 500) that shows utility consumption information of the site 106 and its peer sites to reflect a change due to the selection of these peer sites for this site 106 of the user 122.

### Exemplary Methods

FIG. 7 shows an example method 700 of displaying utility consumption information. The method of FIG. 7 may, but need not, be implemented in the environment of FIG. 1, the example implementation of FIG. 2, and employ one of the example user interfaces of FIGS. 3-5 and 6A-6C. For ease of explanation, method 700 is described with reference to FIGS. 1-5 and 6A-6C. However, the method 700 may alternatively be implemented in other environments and/or using other devices or systems.

Method 700 may be understood in the general context of computer-executable instructions. Generally, computer-executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer-executable instructions may be located in local and/or remote computer storage media, including memory storage devices.

The exemplary methods are illustrated as a collection of blocks in a logical flow graph representing a sequence of operations that can be implemented in hardware, software, firmware, or a combination thereof. The order by which operations within the methods are described is not intended to be construed as a limitation, and any number of the described method blocks may be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations.

Referring back to FIG. 7, at block 702, the utility consumption information system 102 obtains first time-series consumption data from a previous billing cycle for a site 106. The previous billing cycle may include a previous (actual) utility billing cycle of last month, a previous virtual billing cycle, for example.

At block 704, the utility consumption information system 102 obtains second time-series consumption data since or after the previous billing cycle for the site 106. In one implementation, the number of days covered in the second time-series consumption data may be described as n days while the number of days covered in an actual or current utility billing cycle is N, with 0≦n≦N.

At block 706, if the previous billing cycle of the first time-series consumption data is a previous virtual billing cycle, the utility consumption information system 102 may substitute the second time-series consumption data for a portion of the first time-series consumption data. For example, the utility consumption information system 102 may substitute the second time-series consumption data for a portion of the first time-series consumption data having an equivalent amount of time (i.e., n days) at the beginning of the first time-series consumption data to form third time-series consumption data. Alternatively, if the previous billing cycle of the first time-series consumption data is a previous utility billing cycle (e.g., of last month), the utility consumption information system 102 may combine the second time-series consumption data with a latest or most recent portion of the first time-series consumption data. For example, the utility consumption information system 102 may combine the second time-series consumption data with a latest or most recent portion of the first time-series consumption data that spans a number of days equal to (N−n) days to form third time-series consumption data.

At block 708, the utility consumption information system 102 may sum up the third consumption data to obtain a total consumption value or quantity. Additionally, in some implementations, the utility consumption information system 102 may apply a current billing or utility rate to the third time-series consumption data to compute a total cost of the (current) virtual billing cycle.

At block 710, the utility consumption information system 102 calculates or determines a bill-to-date utility cost or fee within the actual or current utility billing cycle.

At block 712, the utility consumption information system 102 displays the calculated utility cost of the virtual billing cycle and/or the bill-to-date utility cost in a user interface (such as the user interface 300).

At block 714, the utility consumption information system 102 obtains benchmark time-series data of the utility service. In one implementation, the benchmark data can be time aligned with the VBC, and may be used as a reference for comparison with the VBC totals and costs.

At block 716, the utility consumption information system 102, totalizes and applies a utility cost rate to the benchmark data.

At block 718, the utility consumption information system 102 may process the utility consumption data or additional utility consumption data to obtain other benchmarks or statistical data and one or more references (such as L, P and G references as described in the foregoing implementations). In an event that an additional or alternative benchmark is included, needed or requested, the utility consumption information system 102 may repeat the processing as described in block 716 (and/or block 714).

At block 720, the utility consumption information system 102 displays or presents a result of the comparison in the user interface to the user 122. The utility consumption information system 102 may present the benchmark data and/or statistical data with respect to the one or more references in the user interface to the user 122. The utility consumption information system 102 may present the statistical data in a single page or in multiple pages.

At block 722, the utility consumption information system 102 may optionally receive a further input or instruction from the user 122 to present other benchmark data, statistical data and/or other references. The utility consumption information system 102 may receive a request from the user 122 to modify a setting, such as altering a range or granularity of time used for computing the VBCs, selecting a certain VBC from a plurality of predefined VBCs, etc.

At block 724, depending on what input or instruction is received from the user 122, the utility consumption information system 102 may update the user interface or modify the setting as instructed by the user 122.

At block 726, the utility consumption information system 102 may normalize the utility consumption data or information based on one or more changed conditions. The one or more changed conditions may include, for example, a change in weather, a change in season, a change in utility rate, a change in utility rate plan, a change in size of household associated with the site, etc. For example, if the utility rate increases, an increase in the utility cost may or may not be due to behavior of the user 122. In order reflect or account for effects of the behavior of the user 122 on the utility cost, the utility consumption information system 102 may normalize the utility cost or the utility rate, for example, by normalizing the utility rate to a predetermined value (such as one) and using this normalized utility rate to calculate the utility cost of a virtual billing cycle, for example. This normalization facilitates comparison between utility costs between different virtual billing cycles or time periods, and therefore helps the user 122 to determine the actual effects of his/her behavior on the utility costs, for example. In some implementations, after normalization, the utility consumption information system 102 may display the normalized information or data in the user interface for presentation to the user 122.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media such as one or more computer storage media.

### CONCLUSION

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A method comprising:
under control of one or more processors configured with executable instructions:
obtaining first consumption data of a utility service associated with a site of a user, based on a first virtual billing cycle representative of a rolling period of consumption;
obtaining second consumption data of the utility service that is usable as a reference to be compared with the first consumption data;
comparing the first consumption data with the second consumption data; and
presenting a result of the comparing to the user.

2. The method as recited in claim 1, wherein the second consumption data comprises utility consumption data associated with one or more other users over a same time period associated with the first consumption data, a utility consumption associated with the site of the user over a previous time period, a target utility consumption set of the user, or a weighted combination thereof.

3. The method as recited in claim 1, further comprising:
applying a time window and a utility cost rate to the first consumption data to obtain the first virtual billing cycle; and
applying the time window and the utility cost rate to the second consumption data to obtain a second virtual billing cycle, wherein:
each of the first virtual billing cycle and the second virtual billing cycle comprises a number of time points and associated utility costs at respective time points, and
comparing the first consumption data with the second consumption data comprises comparing the first virtual billing cycle with the second virtual billing cycle.

4. The method as recited in claim 1, wherein the site comprises a real property site or an appliance.

5. The method as recited in claim 1, wherein obtaining the first consumption data comprises obtaining the first consumption data from a utility meter installed at the site of the user and/or obtaining the first communication data over a communication network.

6. The method as recited in claim 1, wherein obtaining the second consumption data comprises obtaining the second consumption data from a utility service provider over a communication network.

7. The method as recited in claim 1, wherein the result of the comparing enables the user to determine whether a change in the first consumption data is due to an environmental factor common to the site and one or more other sites associated with the second consumption data.

8. The method as recited in claim 1, further comprising presenting a trend of the first consumption data with respect to consumption data in one or more previous time periods.

9. The method as recited in claim 1, further comprising presenting a rate of change associated with the first consumption data with respect to consumption data in one or more previous time periods.

10. The method as recited in claim 1, wherein the utility service comprises a water service, a gas service and/or an electricity service.

11. The method as recited in claim 1, wherein the result comprises one or more graphical indicators representing one or more differences between the first consumption data and the second consumption data.

12. A user interface presented in a display, comprising a plurality of indicators that compare utility consumption associated with a site to other related utility consumption data, wherein the plurality of indicators comprises:
one or more indicators that indicate a utility consumption level associated with the site;
one or more indicators that indicate a trend of the utility consumption over a plurality of time periods; and
one or more indicators that describe comparison results between the utility consumption and the other related utility consumption data.

13. The user interface as recited in claim 12, wherein the plurality of indicators comprises a graphical object indicating a direction representing a trend of the utility consumption of the site with respect to one or more previous time periods.

14. The user interface as recited in claim 13, wherein a size of the graphical object represents an amount of utility consumption associated with the site.

15. The user interface as recited in claim 13, further comprising a plurality of ripples behind the graphical object, wherein a position of each ripple represents a magnitude of utility consumption at a respective time point, and wherein a separation between successive ripples of the plurality of ripples indicates a rate of change of utility consumption of the site.

16. The user interface as recited in claim 13, wherein the graphical object is configured to change color in response to changes in energy consumption.

17. The user interface as recited in claim 12, wherein the plurality of indicators comprises one or more computed values of the utility consumption associated with the site, the one or more computed values comprising a value of the utility consumption, a previous value of the utility consumption and/or a peak value of the utility consumption.

18. The user interface as recited in claim 12, wherein the other related utility consumption data comprises utility consumption associated with one or more other sites over a same time period for the utility consumption of the site, utility consumption associated with the site over a previous time period, target utility consumption set up by a user for the site, or a weighted combination thereof.

19. The user interface as recited in claim 12, wherein the plurality of indicators are displayed in multiple pages, and the user interface further comprises a switch to enable a user to switch between the multiple pages to view the plurality of indicators.

20. A system comprising:
a processing unit;
memory storing executable instructions that, when executed by the processing unit, cause the processing unit to perform acts comprising:
obtaining first consumption data that comprises utility consumption data collected in a subset of a time period associated with an actual billing cycle;
obtaining second consumption data that comprises utility consumption data collected in a time period previous to the time period associated with the actual billing cycle;
applying a time window and a utility cost rate to the first consumption data and the second consumption data to obtain a virtual billing cycle; and
calculating a utility cost for the virtual billing cycle.
